(19) United States
(12) Patent Application Publication
(10) Pub. No.: US 2008/0184943 A1
(43) Pub. Date: Aug. 7, 2008

(54) ANIMAL TRAINING DEVICE

(76) Inventor: Monika Brauer, Owen Sound (CA)

Correspondence Address: THADDIUS J. CARVIS, 102 NORTH KING STREET, LEESBURG, VA, 20176, US

(21) Appl. No.: 12/020,757

(22) Filed: Jan. 28, 2008

(30) Foreign Application Priority Data
Feb. 5, 2007 (CA) 2579946

(51) Int. Cl. A01K 27/00

(52) U.S. Cl. 119/792

(57) ABSTRACT

A training device for dogs and the like has an upper collar that fits high-up on the neck of the animal and a second, lower collar that fits around the lower part of its neck. Spacer means hold the two collars apart in mutually spaced relation, to position the leash, connected to the upper collar, in the most effective location for controlling the creature. The spacer means may comprise a plurality of spacer straps arranged in mutually spaced relation about the two collars.

### TECHNICAL FIELD

The present invention is directed to an animal training device for use in training an animal such as a dog, by the provision of an improved collar having means to retain it in a raised location about the neck of the animal, for consistent application of leash-forces at an optimal location. A particular device embodiment incorporates two collars in mutually spaced relation, having spacing means extending in spacing relation between the two collars.

### BACKGROUND

In the past, training of animals such as dogs has relied upon a single tether means such as a collar placed about the neck of the animal, and having a leash attached thereto. These collars typically consisted of a strap or a chain, to which a leash is attached, or wherein the chain may also constitute a leash, by which to apply pressure to the neck and head of the animal as a means of modifying its immediate behavior.

A major problem is frequently encountered, caused by the displacement of the collar downwardly along the animal's neck, such that the leash-forces applied by the trainer or handler are effectively diminished or negated, being applied to the more muscular and less responsive portion of the creature's lower neck.

### BRIEF SUMMARY OF THE INVENTION

The present invention provides an animal training device for attachment of a leash to the neck of an animal such as a dog, comprising a first, top collar portion forming a first loop to fit high-up on the neck of the animal, a second, lower collar portion forming a second loop to fit low-down on the neck of the animal; spacer means extending between the collar portions to maintain them in predetermined, mutually spaced relation; and leash attachment means secured to the top collar portion, in use to receive a leash in secured relation with the device, whereby the leash attachment is retained in an elevated location, to position the leash for consistent and effective physical control of the animal.

The aforesaid spacer means may consist of at least one spacer strap means in connecting relation with the top and the bottom collar portions. The spacer means may consist of a plurality of strap means located in mutually spaced relation about the collar portions.

The subject strap means may have looped ends, to receive the first collar portion and the second collar portion in inserted relation through respective ones of these looped ends.

The first collar portion may include adjustment means, to enable adjustment to the size of the collar loop, as may the second collar portion.

Each of the collar portions may be individually provided with clasp means to enable their respective opening and closing, to facilitate their attachment to, and removal from the animal.

In addition to maintaining the top collar portion in its raised, optimal location, the spacer means may also serve to maintain the leash attachment point at a preferred location, by preventing rotation of the collar about the animal's neck, when in use.

### BRIEF DESCRIPTION OF THE DRAWINGS

Certain embodiments of the invention are illustrated, by way of example, without limitation of the invention thereto, other than as set forth in the accompanying claims; it being understood that further embodiments may be derived by one skilled in the art.

Reference is made to the accompanying drawings, wherein:

FIG. 1 is a perspective view of an animal training device made in accordance with the present invention;

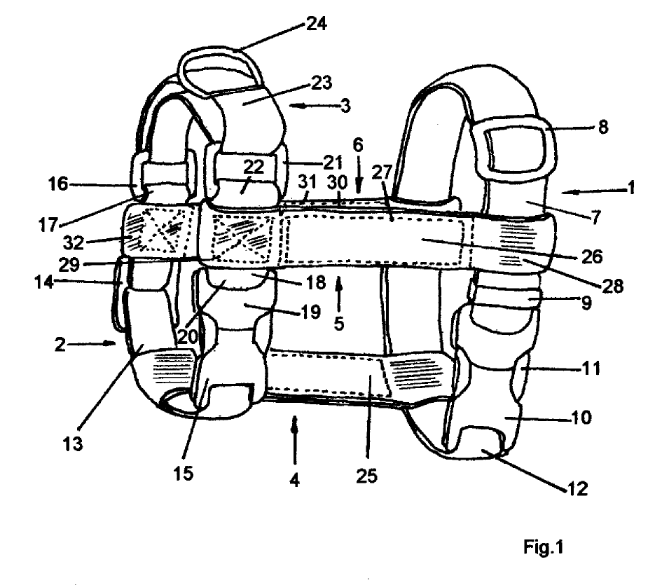

FIG. 2 is a perspective view of the animal training device shown in place on a dog;

FIG. 3 is a perspective view of the animal training device shown from the front; and

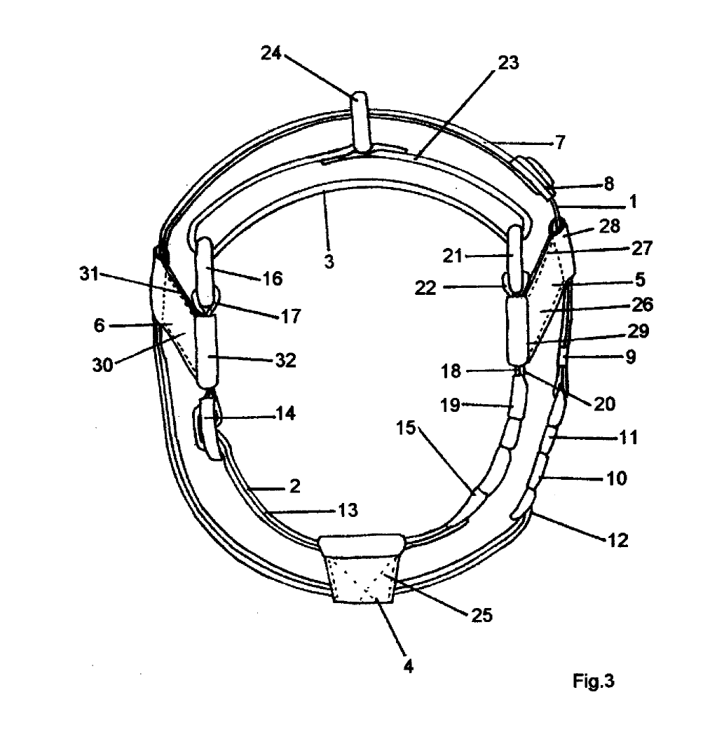

FIG. 4 is a perspective view of the animal training device shown from the top.

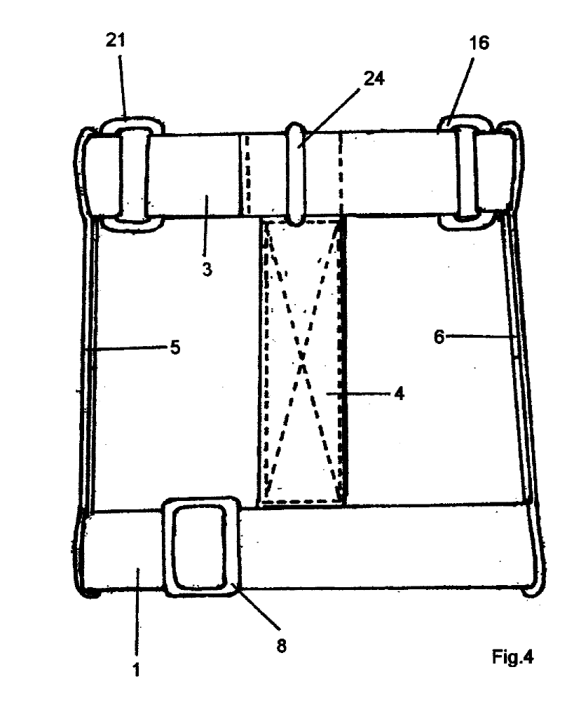

### DETAILED DESCRIPTION

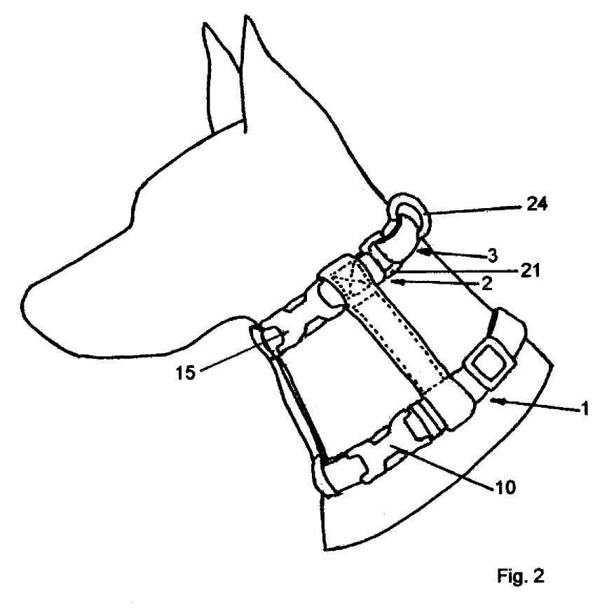

The subject collar type device which may be utilized to train an animal that is primarily intended to be used in conjunction with the training of a dog as shown in FIG. 2, but, it should be understood that it could be used in conjunction with other types of animals.

However, the discussion herein, will be based on its' use with a dog. The device includes a lower neck strap 1 and an upper neck strap 2. Strap 2 is connected to itself with a strap formed as a loop 3.

Strap 1 and strap 2 are connected by a bottom strap, 4 and two side straps 5 and 6. Lower neck strap 1 is preferably in the form of a loop of flat, flexible, band-like material such as polyester, nylon, leather or webbing like material 7. For the purpose of this description it will be referred to as webbing.

A conventional slide adjuster 8 is provided on one end of webbing 7, which enables the user to adjust the size of the lower neck strap 1.

During the assembly of lower neck strap 1 the webbing 7 is fed through the slide adjustor 8, then through a slide loop 9. Subsequently receiving one end of a conventional locking clasp generally, 10. The webbing 7, is then fed back through the slide loop 9 and then through the slide adjustor 8 subsequently forming a small loop which is attached to the webbing 7, for example by stitching, gluing, riveting or other methods of fastening.

The remaining end of the webbing 7 is provided with a loop 12 that will receive the second half of the locking clasp.

A conventional locking clasp 10 includes side tabs 11 which, when depressed, allows the clasp 10 to be opened for ease of positioning strap 1 on the dog. It is also possible to use another conventional locking device such as a buckle, button(s), snap(s) or clasp(s). The upper neck strap 2 is also generally in the shape of a loop like structure and preferably made of flat, flexible, band-like material such as polyester, nylon, leather or webbing like material 13. For the purpose of this description it will be referred to as webbing.

During the assembly of the upper neck strap 2 the webbing 13 is fed through the slide adjustor 14, then through one end of a conventional locking devise 15.

The webbing 13 is then fed back through the slide adjustor 14 forming a small loop which is attached to the webbing 13, for example by stitching, gluing, riveting or other methods of fastening.

To continue the assembly of loop 2 the webbing indicated by the number 18 is fed through the second half of a conventional locking device 19, forming a small loop indicated by the number 20 which is attached back to the webbing 18 by means of stitching, gluing, riveting or other method(s) of fastening.

The remaining end of the webbing 18 is fed through a ring-like device 21 forming a small loop 22 which is attached back to the webbing 18.

To form the final loop of the upper neck strap 2 it is connected to itself with a strap formed as a loop indicated by the number 3.

The loop 3 is preferably made of flat flexible, band-like material such as polyester, nylon, leather or webbing like material(s). The following materials could also be used: chain-like devices, rope or cable-like devices. For the purpose of this description it will be referred to as webbing.

One end of webbing 23 is fed through ring 21 and subsequently through ring 16. Both ends of webbing 3 overlap each other, receiving a ring-like device 24 that is fastened by the over-lapping ends to each other by stitching, gluing, riveting or other method(s) of fastening.

Strap 1 and strap 2 are connected by a bottom strap 4 and two side straps 5 and 6. Strap 4, 5 and 6 are preferably made of flat, flexible, band-like material such as polyester, nylon, leather or webbing-like material(s).

These straps 4, 5 and 6 are sufficiently stiff that, in use, they maintain the ‘collar’ straps 1 and 2 in predetermined, mutually spaced relation.

During the assembly of strap 4 the webbing 25 is wrapped around the webbing 13 of the upper neck strap 2 forming a loop allowing the strap to slide for a proper fit.

The other end of strap 4 the webbing 25 is wrapped around the webbing 7 of the lower neck strap 1 forming a loop allowing slide-ability. To secure both ends of strap 4 the webbing 25 are overlapped and stitched, glued, riveted or fastened in any other way that still maintains the slide-ability of both loops.

During the assembly of strap 5 the webbing 26 is wrapped around the webbing 13 of the upper neck strap 2 just below ring 21. The other end of the webbing 26 is wrapped around neck strap 1 just above the slide loop 9. Both ends of webbing 26 over-lapping each other and for example stitched together as 27, leaving a loop 28 around strap 1 for slide-ability. The loop 29 is fastened to the upper neck strap 2 by way of stitching, riveting, gluing or any other method(s) of fastening.

During the assembly of strap 6 the webbing 30 is wrapped around the webbing 13 of the upper neck strap 2 just below ring 16.

The other end of the webbing 30 is wrapped around the lower neck strap 1 opposite of strap 5. Both ends of webbing 30 over lapping each other and for example stitched together 31, leaving a loop around strap 1 for slide-ability.

The loop 32 is fastened to the upper neck strap 2 just below ring 16, opposite of strap 5 by way of stitching, riveting, gluing or any other method(s) of fastening.

To position the double collar training device on the dog open the clasp 10 of the lower neck strap 1 and place neck strap 1 around the dogs lower part of the neck just above the shoulders.

The slide adjustor 8 may be moved along the webbing 7 lengthening or shortening neck strap 1 to adjust to for a proper fit.

Once neck strap 1 is placed around the dog's neck close clasp 10 and proceed to place upper neck strap 2 around the dogs' neck.

Open clasp 15 and position upper neck strap 2 around the upper portion of the dog's neck close to the dogs' skull, close the clasp, adjust the slide adjuster 14 until the collar fits snug around the dogs' neck. Connect leash to ring 24, by tugging on the leash, loop 3 tightens neck strap 2 by pulling ring 16 and 21 closer together, thereby, providing even pressure around the dogs' neck. It is this pressure in conjunction with the appropriate commands that will let the dog know to correct its' immediate behavior.

1. An animal training device for attachment of a leash to the neck of an animal such as a dog, comprising a first, top collar portion forming a first loop to fit high-up on the neck of the animal, a second, lower collar portion forming a second loop to fit low-down on the neck of the animal; spacer means extending between the collar portions to maintain them in predetermined, mutually spaced relation; and leash attachment means secured to said top collar portion, in use to receive a leash in recurred relation with the training device, whereby said leash attachment means is retained in an elevated position, to position said secured leash for consistent physical control of said animal.

2. The training device as set forth in claim 1, wherein said spacer means consists of at least one spacer strap means in connecting relation with said top and said bottom collar portions.

3. The Training device as set forth in claim 2, wherein said spacer means consists of a plurality of said strap means located in mutually spaced relation about said collar portions.

4. The training device as set forth in claim 3, said strap means having looped ends, to receive said first collar portion and said second collar portion in inserted relation through respective ones of said looped ends.

5. The training device as set forth in claim 1, wherein said first collar portion includes adjustment means, to enable adjustment to the size of said first loop.

6. The training device as set forth in claim 5, wherein said second collar portion includes adjustment means to enable adjustment to the size of said second loop.

7. The training device as set forth in claim 1, wherein said first collar portion includes clasp means to enable opening and closing of said first loop.

8. The training device as set forth in claim 7, wherein said second collar portion includes clasp means to enable opening and closing of said second loop.
